(19) United States
(12) Patent Application Publication
(10) Pub. No.: US 2007/0225172 A1
(43) Pub. Date: Sep. 27, 2007

(54) Porous Carbon Material Impregnated With a Liquid By-Product of Amino Acid Fermentation

(76) Inventors: Toshiaki Moriya, Yokohama-shi (JP); Koji Yumura, Yokohama-shi (JP); Kotaro Sakamoto, Yokohama-shi (JP); Satoru Motoki, Nagano-shi (JP); Keiji Shimizu, Nakano-shi (JP); Kazuhiko Takahasi, Nakano-shi (JP); Hidekazu Kasahara, Nakano-shi (JP)

Correspondence Address: CERMAK & KENEALY LLP;ACS LLC, 515 EAST BRADDOCK ROAD, SUITE B, ALEXANDRIA, VA, 22314, US

(21) Appl. No.: 11/749,887

(22) Filed: May 17, 2007

Related U.S. Application Data
(63) Continuation of application No. PCT/JP05/20992, filed on Nov. 9, 2005.

(30) Foreign Application Priority Data
Nov. 19, 2004 (JP) 2004-335443

(51) Int. Cl. A01N 25/00

(52) U.S. Cl. 504/358

(57) ABSTRACT

The present invention provides a porous carbon material which has been impregnated with a liquid by-product of an amino acid fermentation. The impregnated porous carbon material is effective as a countermeasure against soil injury and plant physiological disorders, and promotes the growth of plants from planting to harvest, and even is useful in continuous cropping.

This application is a continuation under 35 U.S.C. § 120 of PCT/JP2005/020992, filed Nov. 9, 2005, which claims priority under 35 U.S.C. § 119 to JP-2004-335443, filed Nov. 19, 2004. Both of these documents are hereby incorporated by reference.

### BACKGROUND OF THE INVENTION

1. Field of the Invention

This invention relates to a material which has been impregnated with a liquid by-product of an amino acid fermentation, and to a method for producing the same.

2. Brief Description of the Related Art

In the rhizosphere soil of fields used for agriculture, such as for various crops and fruit trees, and the like, substances which are harmful to the plants may exist. These substances include various gases caused by the metabolic reaction of microorganisms present in the soil, dioxins, and residual agricultural chemicals. Accumulation of these harmful substances in the soil may cause simplification of the rhizosphere microorganism phase, reduction of the bacteriostatic action, proliferation of germs, and the like, resulting in soil which is particularly suceptible to injury. In addition, a phenomenon called allelopacy may occur. This is induced by a harmful material which originates from a plant. Allelopacy is a phenomenon in which a chemical substance released from a plant has some influence on other plants or microorganisms. Allelopacy is considered to be one of the transition factors of vegetation in the natural ecosystem, and to be one of causes of growth inhibition or continuous cropping injury (soil-disliking phenomenon) in field crops and permanent crops such as fruit trees.

Agricultural techniques have progressed in recent years. In order to reduce and control soil injury and plant physiological disorders, countermeasures have been introduced. These include the systematic rotation of crops, adding large amounts of organic materials such as compost or soil treatment agents (rooting agent, growth promoting agent, or the like), or disinfecting the soil using agricultural chemicals or heat. However, these countermeasures are only effective when a substance has been recently added, for example, the application of an organic material, or when various properties of the soil have been sacrificed. Thus, these known countermeasure methods are not effective when harmful substances accumulate in the rhizosphere soil.

A porous carbon material can act to remove harmful substances which accumulate in soil to reduce soil injury and plant physiological disorders. In particular, activated carbon has been used to condition soil. Since activated carbon can adsorb and remove harmful substances which accumulate in rhizosphere soil, dispersion of activated carbon is much more effective as a countermeasure against harmful substances. Furthermore, activated carbon is able to constantly supply oxygen into the soil via the adsorption-desorption reaction thereof, maintaining the moisture of the soil, and adjusting the balance of soil microorganisms. Thus, it is very useful as a soil conditioner. For example, asparagus, which is a perennial Liliaceae plant, increases in yield when activated carbon is dispersed and blended into the soil (VEGETABLE AND ORNAMENTAL CROPS EXPERIMENT STATION, Agricultural technology to be newly popularized, (2001), Second session, Reference No. 6 “Treatment with particulate activated carbon “HJA-40Y” upon replantation of asparagus can reduce allelopacy.” [online] January 6, (2003), Nagano Agricultural Comprehensive Research Center [Oct. 13, (2004)]; VEGETABLE AND ORNAMENTAL CROPS EXPERIMENT STATION, Agricultural technology to be newly popularized, (2002), Second session, Reference No. 14 “Treatment with particulate activated carbon “HJA-100CW” upon replantation of asparagus can reduce allelopacy.” [online] Jan. 6, 2003, Nagano Agricultural Comprehensive Research Center [Oct. 13, 2004]). Therefore, treatment of asparagus crops with activated carbon is increasing. Furthermore, treatment with activated carbon is being attempted for various crops.

Furthermore, activated carbon can also be used as a carrier, by absorbing another material onto the activated carbon. For example, a palm shell activated carbon having a silk amino acid adsorbed thereon, and a fertilizer prepared by absorbing nitrogen, phosphoric acid, potassium, mineral or the like, onto a carbide of beer lees or the like, have been reported (JP-A-2001-226183).

### SUMMARY OF THE INVENTION

It is an object of the present invention to provide porous carbon materials which have been impregnated with an amino acid fermentation by-product which are effective as a countermeasure against the origin of soil injuries and plant physiological disorders, and promote growth of plants from the initial planting to the harvest, and can even be used effectively in continuous cropping. It is another object of the present invention to provide methods for producing the same.

A material has been derived which is able to condition and fertilize the soil simultaneously. This is accomplished by impregnating the surface of a porous carbon material with an amino acid fermentation liquid by-product.

It is an object of the present invention to provide porous carbon material which is impregnated with an amino acid fermentation liquid by-product.

It is an object of the present invention to material as described above, which is a solid.

It is an object of the present invention to provide the material as described above, in which is a slurry.

It is an object of the present invention to provide the material as described above, wherein the surface area of the said porous carbon material is from 600 to 2,000 m²/g.

It is an object of the present invention to provide the porous carbon material as described above, comprising from 1 to 70% by weight of said liquid by-product.

It is an object of the present invention to provide the porous carbon material as a slurry as described above, comprising from 70 to 99% by weight of said liquid by-product.

It is an object of the present invention to provide a soil conditioner comprising porous carbon material as described above.

It is an object of the present invention to provide a method for producing a porous carbon material impregnated with an amino acid fermentation liquid by-product comprising:

A) mixing a porous carbon material with a liquid by-product of an amino acid fermentation, and

B) recovering the impregnated porous carbon material.

It is an object of the present invention to provide method for producing a porous carbon material impregnated with a liquid by-product of an amino acid fermentation in slurry comprising:

A) finely pulverizing the porous carbon material,

B) mixing the pulverized porous carbon material with the liquid by-product of an amino acid fermentation,

C) recovering the porous carbon material impregnated with a liquid by-product of an amino acid fermentation as a slurry.

By blending the porous carbon material with the soil before planting or transplanting of fruit, vegetables including leaf and root vegetables, flowering plants, and fruit trees, increased growth and yield can be obtained. In particular, a large increase in root weight is observed. These effects are not seen, nor would they be expected, from treating the soil with a porous carbon material and a liquid by-product of an amino acid fermentation separately, and therefore, these effects are synergistic.

### DESCRIPTION OF THE PREFERRED EMBODIMENTS

The present invention provides a porous carbon material, including carbonaceous materials in general. These materials typically have many fine pores from being burned. Examples thereof include wood charcoal and activated carbon. The porous carbon material has many functions due to its porous structure, such as molecular adsorption, catalytic action, use as a support for a catalyst or a drug, humidity conditioning, acting as a molecular sieve, and the like. In particular, the surface area of the porous carbon material as described herein is preferably from 250 to 2,000 m²/g, and particularly preferably from 900 to 2,000 m²/g.

Wood charcoal, for example, has a surface area of around from 250 to 600 m²/g. Alternatively, activated carbon has a surface area around from 600 to 2,000 m²/g, and is prepared by further developing the pores of wood charcoal or the like with steam, chemical activation, or the like. Specifically, activated carbon prepared by activating wood charcoal, palm shell charcoal, coal, or the like, with steam or chemicals is preferred. All surface area values are determined by a volumetric method based on the nitrogen gas adsorption method.

The liquid by-product of an amino acid fermentation includes the liquid by-product obtained when isolating and purifying any kind of amino acid. These include broths from the fermentation of glutamic acid, lysine, glutamine, etc., when fermented from raw materials such as starch and molasses. A specific example includes the effluent obtained by passing a pH-adjusted fermentation broth of lysine, glutamine, or the like through a strongly acidic cationic resin to adsorb the amino acid onto the resin. Another example is the mother liquor obtained by adjusting the pH of a fermentation broth of an acidic amino acid such as glutamic acid or the like to the isoelectric point with a mineral acid, followed by separating the amino acid crystals by precipitation. These liquid by-products contain, in addition to various types of amino acids (typically from 5 to 14% by weight in the concentrated liquid), a lot of nutritive, solid components necessary for plant growth such as sugars, fermentation microorganisms, organic-form nitrogen, inorganic-form nitrogen, vitamins and the like. The total solid content is typically from 30 to 50% by weight. Some of these products have been registered as nitrogen fertilizers and are on the market, such as “PAL” (Registration number: Sei No. 74220), which is a phenylalanine fermentation by-product, and “Glutamine” (Kanagawa-prefecture No. 712), which is a glutamine fermentation by-product. Furthermore, if desired, typical fertilizer ingredients such as nitrogen, phosphoric acid, potassium, minerals, and the like, may be added to these by-products, as long as they do not inhibit the desirable effects.

The porous carbon material which has been impregnated with the liquid by-product may be either a solid or a slurry. The term “impregnation” or “impregnated” means “adsorption” or “adsorbed”, or that the carbon material is acting as a support for the by-product, and these terms and concepts may be used interchangeably.

The impregnated solid porous carbon material is produced by mixing a liquid amino acid fermentation by-product and a porous carbon material in, for example, a drum mixer, to allow the entire surface of the porous carbon material to become impregnated with the liquid by-product. Then, the pH is adjusted with an acidic solution, preferably aqueous phosphoric acid, so that the pH of the impregnated porous carbon material is lowered to between 5.0 to 8.0 (measured according to JIS standard “JIS K 1474: 1991” of the Japanese Standards Association (Foundation), hereinafter the same applies). Since increased moisture beyond 30% by weight of the impregnated porous carbon material may cause the breeding of mold, it may be dried with hot air following impregnation. Although there is no particular limitation on the ratio of the liquid by-product to the porous carbon material, it is preferred that the ratio is between 1-70 parts by weight of liquid by-product: 99-30 parts by weight of the carbon material. When the drying procedure is omitted, using around 30% by weight of the liquid by-product is particularly preferred.

The impregnated solid porous carbon material can be used with no particular limitations, for example, it can be applied to a whole field, ridges, planting grooves, and planting holes. Blending it into the soil in an amount of from 10 to 1,000 kg/10 a (that is, 10 acres) is preferred.

Alternatively, the impregnated porous carbon material can be produced as a slurry in the following manner. First, a porous carbon material is finely pulverized. Although the diameter of the particles of the carbon material after pulverizing is not particularly limited, an average particle diameter of not more than 150 μm is preferred in order to prevent the porous carbon material from precipitating out of the liquid by-product, but to be well mixed with the liquid. Then, the liquid by-product and the finely pulverized porous carbon material are stirred, for example, to form a slurry. This results in the surface of the porous carbon material to become impregnated with the liquid by-product. The pH can be adjusted with an acidic solution, preferably aqueous phosphoric acid, to a pH of from 5.0 to 8.0. Although the ratio of the liquid by-product to the finely pulverized porous carbon material is not particularly limited, a ratio of 70-90 parts by weight of liquid by-product: 30-10 parts by weight of carbon material is preferred.

When made as a slurry, the impregnated porous carbon material can be applied with no particular limitation, for example, by soil saturation or soil irrigation. Application of 50-500 times diluted liquid per from 1,000 to 20,000 kg/10 a is preferred.

### EXAMPLES

Hereinafter, the present invention will be described in greater detail by the following non-limiting examples. In the manufacturing examples, “part” means part by weight.

### Manufacturing Example 1

Hereinafter, the method is described for producing a porous solid carbon material impregnated with the liquid by-product of an amino acid fermentation.

(a) 30 parts of a concentrated liquid by-product of an amino acid fermentation (Ajinomoto Co, Inc.; glutamine fermentation by-product) was treated with phosphoric acid to give a pH of 4.0 to 5.0, and then added to 70 parts of a particulate activated carbon “HJA-40Y” (manufactured by Ajinomoto Fine-Techno. Co., Inc.). This mixture was then subjected to impregnation in a drum mixer (manufactured by SUGIYAMA HEAVY INDUSTRIAL CO., LTD.), resulting in a solid porous carbon material impregnated with the liquid fermentation by-product. The final product has a pH of from 5.0 to 8.0 and a moisture content of 30% by weight or less.

(b) The procedure as set forth in (a) above was repeated, except that the liquid glutamine fermentation by-product was replaced with a liquid glutamic acid fermentation by-product, a liquid phenylalanine fermentation by-product, or a liquid lysine fermentation by-product. Using the procedure in (a) above, the solid porous carbon material was impregnated with glutamic acid fermentation by-product, phenylalanine fermentation by-product, and lysine fermentation by-product, respectively.

### Manufacturing Example 2

A method is now described for producing a porous solid carbon material impregnated with a liquid amino acid fermentation by-product, which is then dried.

30 parts of concentrated liquid amino acid fermentation by-product (Ajinomoto Co., Inc.; glutamine fermentation by-product) was treated with phosphoric acid to give a pH of 4.0-5.0, and then added to 50 parts of the particulate activated carbon “HJA-40Y” (see above). This mixture was subjected to impregnation in a drum mixer (manufactured by SUGIYAMA HEAVY INDUSTRIAL CO., LTD.) and dried with hot air at 180° C. Then, an additional 20 parts of the same liquid fermentation by-product was added. A solid porous carbon material impregnated with the amino acid fermentation by-product was obtained. This product has a pH of from 5.0 to 8.0 and a moisture content of 30% by weight or less.

### Manufacturing Example 3

A method is described for producing a porous carbon material impregnated with a liquid amino acid fermentation in the form of a slurry.

The particulate activated carbon “HJA-40Y” (see above) was pulverized into fine particles which have an average diameter of 150 μm or less using a “Roller Mill Model 30-HD” (manufactured by Ishii Funsaiki). 75 parts of liquid concentrated amino acid fermentation by-product (Ajinomoto Co., Inc.; glutamine fermentation by-product) was treated with phosphoric acid to give a pH of 4.0-5.0, and then added to 25 parts of the finely pulverized activated carbon particles. This mixture was stirred to form a slurry and impregnate the carbon. The porous carbon material impregnated with the fermentation by-product in slurry form was thus obtained. This material has a pH of 5.0-8.0.

### Example 1

### Japanese Leaf Vegetable, Komatsuna, Brassica campestris var. perviridis

All of the tests in this example were carried out in pots. Germination and growth of the Japanese leaf vegetable, Komatsuna, was evaluated after application of the solid impregnated porous carbon material (Manufg. Ex. 1). An organic fertilizer, dried mycelium derived from the beer production process (registered by Kanagawa Prefectural Governor) was used as a control. The amounts of added fertilizer in the pots were determined based on the nitrogen content. Three tests were conducted for each of impregnated carbon material, and the control. The first was a standard amount, the second was double the standard amount, and the third was triple the standard. An untreated pot which contained none of the carbon material nor organic fertilizer was also included. To all the pots, 25 mg/pot of N, P₂O₅ and K₂O was added in the form of ammonium sulfate, calcium superphosphate, and potassium chloride, respectively. The test was repeated twice with 40 seeds/pot, using 1/5000 a Wagner pots, and and osol soil (Yachimata-city, Chiba prefecture).

Table 1 shows the results:

TABLE 1

| | Type of | | Result of analysis (%) | | | |
|---|---|---|---|---|---|---|
| | fertilizer | Name of fertilizer | Moisture | N | P₂O₅ | K₂O |
| Test material | | Amino acid fermentation | 24.87 | 1.86 | 1.29 | 1.33 |
| (present | | by-product liquid-impregnated | | | | |
| invention) | | porous carbon material in solid | | | | |
| control | Organic | “Dried mycelium fertilizer derived | 3.76 | 6.48 | 3.62 | 0.63 |
| fertilizer | fertilizer | from beer production process” | | | | |

Analysis agency: Japan Fertilizer and Feed Inspection Association (Foundation)

Observation:

On Mar. 7, 2003, the solid impregnated porous carbon material and the control fertilizer as described above were each blended with soil, seeded with Komatsuna, and grown in a constant temperature greenhouse. The leaf length and fresh weight were checked on March 28, that is, 21 days after seeding. Germination was also checked three times during the period, and the leaf length was checked on March 14. The results are shown in Table 2.

TABLE 2

| | | | Result of germination investigation | | | Result of growth investigation | | | |
|---|---|---|---|---|---|---|---|---|---|
| | | | Mar. 9 | Mar. 10 | Mar. 11 | Mar. 14 | Mar. 28 | | |
| | | Application | Germination | Germination | Germination | Leaf | Leaf | fresh | fresh |
| | | amount | percentage | percentage | percentage | length | length | weight | weight |
| Experimental plot | | (g/pot) | (%) | (%) | (%) | (cm) | (cm) | (g/pot) | index |
| Test material | Standard plot | 2.69 | 68 | 88 | 98 | 2.0 | 11.0 | 22.7 | 131 |
| (present invention) | Double amount plot | 5.38 | 70 | 78 | 95 | 1.9 | 9.8 | 27.1 | 157 |
| | Triple amount plot | 8.06 | 70 | 83 | 93 | 1.9 | 9.8 | 29.7 | 172 |
| Reference fertilizer | Standard plot | 0.77 | 50 | 73 | 95 | 1.8 | 9.0 | 20.2 | 117 |
| | Double amount plot | 1.54 | 65 | 80 | 98 | 1.9 | 8.3 | 21.5 | 124 |
| | Triple amount plot | 2.31 | 63 | 83 | 98 | 1.8 | 8.5 | 22.2 | 128 |

| | | | | | | | | |
|---|---|---|---|---|---|---|---|---|
| Untreated plot | — | 55 | 55 | 83 | 1.9 | 8.8 | 17.3 | (100) |

Analysis agency: Japan Fertilizer and Feed Inspection Association (Foundation)

Results:

The pots treated with the solid impregnated porous carbon material gave, relative to both the germination start date and the germination percentage, equal or better results as compared with the untreated and the control pots, as well as in growth after germination, leaf length, and crude weight. For the pots containing the solid impregnated porous carbon material, particularly, an increase in the weight of the fresh plant was 57% for the double-amount pot, and 72% for the triple-amount pot.

### Example 2

### Round Egg Plant

The solid impregnated porous carbon material (Manufg Ex. 1) and a particulate activated carbon “HJA-40Y” (manufactured by Ajinomoto Fine-Techno. Co., Inc.) were used in an agricultural field test in the second year of repeated cropping to investigate the differences in growth and yield. A round egg plant, Koshinomaru (rootstock: disease resistant VF) was used as the crop. 5 a of a field in the second year of continuous cropping for the round egg plant was used. This field is adjacent to the test field used the previous year. The test was repeated once, using 1.7 a for each plot. The density of the plantings was as follows: row width: 230 cm; distance between the plants: 60 cm; one row planting; and pruning all but the 4 strongest branches. An organic fertilizer “Yuki all eight” (100 kg/10 a), a covering fertilizer “Superlong 424” (150 kg/10 a), and an oyster shell fertilizer “Sunlime” (100 kg/10 a) were applied, and pathogen and pest control was carried out by a conventional method.

The compositions of the experimental plots were as follows:

(a) Untreated plot: the aforementioned fertilizers only (no test materials)

(b) Experimental plot 1: the aforementioned fertilizers+60 kg/10 a of “HJA-40Y” (broadcast application);

(c) Experimental plot 2: the aforementioned fertilizers+60 kg/10 a of the solid impregnated porous carbon material (broadcast application).

Observations:

The small seedlings were planted on May 11, 2002. The growth, stem diameter at the base, plant height, number of nodes, and root weight were noted for 10 round egg plants in each plot. The results are shown in Table 3. The yield from 40 plants/plot plot was measured for the first 5 days of each month. The results are shown in Table 4.

TABLE 3

| | Investigation date | | | | | |
|---|---|---|---|---|---|---|
| | Aug. 10 | | | Nov. 11 | | |
| | Plant height | Number of nodes | Stem diameter | Stem diameter | Root weight of | |
| | (cm) | (node) | (mm) | (mm) | one stock (g) | |
| | average of | average of | average of | average of | average of | Root weight |
| | 10 stocks | 10 stocks | 10 stocks | 10 stocks | 10 stocks | index |
| Untreated plot | 130.7 | 13.0 | 26.1 | 27.3 | 137.0 | (100) |
| Experimental plot 1 | 132.0 | 13.0 | 27.4 | 29.5 | 172.6 | 126 |
| Experimental plot 2 | 135.2 | 14.0 | 26.0 | 27.4 | 171.2 | 125 |

Method of investigating the root weight: circumference 20 cm apart from a stock was dug with a sward scoop

TABLE 4

| | Investigation date | | | | | |
|---|---|---|---|---|---|---|
| | Jul. 1-5 | Aug. 1-5 | Sep. 1-5 | Oct. 1-5 | Total | Index |
| Untreated plot | 45.0 | 51.6 | 38.9 | 43.0 | 178.5 | (100) |
| | (kg) | (kg) | (kg) | (kg) | | |
| Experimental plot | 57.0 | 58.5 | 46.1 | 53.0 | 214.6 | 120 |
| 1 | | | | | | |
| Experimental plot | 86.6 | 63.4 | 49.3 | 62.5 | 261.8 | 147 |
| 2 | | | | | | |

Yield investigation for 40 stocks in each plot (yield for the first 5 days of each month)

Results:

Although no large differences in growth were observed among the plots, the plots with the solid impregnated porous carbon material or “HJA-40Y” exhibited slightly better results, as compared with the untreated plot. However, the plots with “HJA-40Y” or the solid impregnated porous carbon material exhibited around a 25% increase in root weight, as compared with the untreated plot.

The following yields were obtained, as compared to the untreated plot: a 20% increase was observed for Experimental plot 1 (60 kg/10 a of “HJA-40Y”), and a 47% increase was observed for Experimental plot 2 (60 kg/10 a of the solid impregnated porous carbon material. Therefore, the solid impregnated porous carbon material has a greater effect on yield, as compared with the activated carbon, although the effect on growth is nearly equal. In addition, since growth promotion, especially an increase in root weight, and yield were observed for the second year in repeated cropping, the solid impregnated activated carbon has a large effect on plant growth even for continuously cropped soil.

### Example 3

### Round Egg Plant

Example 2 was repeated to determine the appropriate amount of the solid impregnated porous carbon material which should be used. To this end, increasing amounts of the impregnated porous carbon material were applied and the effects observed. Calcium peroxide (Nippon Caloxide Co., Ltd.), which is widely used to supply oxygen, and citric acid (Eisai Seikaken Co., Ltd.), which is widely used for root stimulation, were used for reference. 2 a of an agricultural field in the second year of continuous cropping for the round egg plant was used. Again, this field was adjacent to the test field used the previous year. The test was repeated once, using 0.4 a for each plot. The subject crop, cultivation density, application of fertilizers, and disease and pest control were the same as those in Example 2.

The composition of the experimental plots were as follows:

(a) Untreated plot: the aforementioned fertilizers only (no test materials);

(b) Experimental plot 1: the aforementioned fertilizers+30 kg/10 a of calcium peroxide and 60 kg/10 a of citric acid (broadcast application);

(c) Experimental plot 2: the aforementioned fertilizers+40 kg/10 a of the solid impregnated porous carbon material (broadcast application);

(d) Experimental plot 3: the aforementioned fertilizers+60 kg/10 a of the solid impregnated porous carbon material (broadcast application);

(e) Experimental plot 4: the aforementioned fertilizers+80 kg/10 a of the solid impregnated porous carbon material (broadcast application).

Observations:

The plants were planted carried out on May 3, 2003 and, the growth, stem diameter at the base, plant height, number of nodes, and root weight were observed for each plot of plants. The results are shown in Table 5. 10 plants per plot were observed, and the yield was measured for the first 5 days of each month. The results are shown in Table 6.

TABLE 5

| | Investigation date | | | | |
|---|---|---|---|---|---|
| | Sep. 22 | Sep. 22 | Oct. 1 | Nov. 16 | |
| | Plant height | Number of nodes | Stem diameter | Root weight of | |
| | (cm) | (node) | (mm) | one stock (g) | |
| | average of | average of | average of | average of | Root weight |
| | 10 stocks | 6 stocks | 10 stocks | 5 stocks | index |
| Untreated plot | 149.9 | 20.0 | 28.5 | 205 | (100) |
| Experimental plot 1 | 151.8 | 21.0 | 29.6 | 250 | 122 |
| Experimental plot 2 | 144.0 | 21.3 | 27.9 | 225 | 110 |
| Experimental plot 3 | 156.1 | 20.8 | 29.0 | 260 | 127 |
| Experimental plot 4 | 151.6 | 20.5 | 31.8 | 265 | 129 |

TABLE 6

| | Investigation date | | | | |
|---|---|---|---|---|---|
| | Jul. 1-5 | Aug. 1-5 | Sep. 1-5 | Total | Index |
| Untreated plot | 15.0 (kg) | 9.7 (kg) | 8.5 (kg) | 33.2 | (100) |
| Experimental plot 1 | 18.0 | 9.2 | 8.8 | 36.0 | 108 |
| Experimental plot 2 | 19.0 | 11.6 | 8.7 | 39.3 | 118 |
| Experimental plot 3 | 20.5 | 12.0 | 9.8 | 42.3 | 127 |
| Experimental plot 4 | 22.0 | 12.0 | 10.6 | 44.6 | 134 |

Yield investigation for 10 stocks in each plot (yield for the first 5 days of each month)

Results:

As for growth, there was not a large difference between the solid impregnated porous carbon material plot and Experimental plot 1 (with calcium peroxide and citric acid), as compared with the untreated plot. However, an increase in root weight was observed in the plot with calcium peroxide and citric acid and the plot with the solid impregnated porous carbon material, as compared with the untreated plot.

With regard to yield, an increase of 8% was observed for Experimental plot 1, and an increase of 18-34% for Experimental plots 2-4, all as compared with the untreated plot.

Although the plots with the impregnated porous carbon material (Experimental plots 2-4), as compared with the plots with calcium peroxide and citric acid (Experimental plot 1), had approximately the same growth, a greater effect was observed for yield. Thus, the impregnated porous carbon material is effective for improving plant growth, even in the second year.

Furthermore, the effective amount of the solid impregnated porous carbon material was determined to be 60 to 80 kg/10 a.

### Example 4

### Tomato

The effect on growth of the tomato “Momotaro eight” using the solid impregnated porous carbon material was investigated. The solid impregnated porous carbon material (Manufg Ex. 1) and a granular activated carbon “HJA-40Y” (manufactured by Ajinomoto Fine-Techno. Co., Inc.) were used. As in Example 3, calcium peroxide (Nippon Caloxide Co., Ltd.) and citric acid (Eisai Seikaken Co., Ltd.) were used for reference.

The cultivation was carried out, for each experimental plot, by planting 6 tomatoes in a drain bed (isolated bed) in a test greenhouse. For all the plots, the organic fertilizer “Bionorganic S” (50 kg/10 a), the delayed release fertilizer “Superlong 424” (100 kg/10 a), “Sunlime plus” which is a fertilizer of oyster shells blended with magnesium hydroxide, and another delayed release fertilizer “Long Syocal 140” (20 kg/10 a) were used, and disease and pest control was carried out by a conventional method.

The composition in the experimental plots were as follows:

(a) Untreated plot: the aforementioned fertilizers only (no test materials);

(b) Experimental plot 1: the aforementioned fertilizers+30 kg/10 a of calcium peroxide and 60 kg/10 a of citric acid (broadcast application);

(c) Experimental plot 2: the aforementioned fertilizers+60 kg/10 a of “HJA-40Y” (broadcast application);

(d) Experimental plot 3: the aforementioned fertilizers+60 kg/10 a of the impregnated porous carbon material (broadcast application);

(e) Experimental plot 4: the aforementioned fertilizers+80 kg/10 a of the impregnated porous carbon material (broadcast application).

Observations:

The small plants were planted on May 29, 2003, and the average growth of the 6 tomato plants in each plot were observed by measuring the stem diameter at the soil surface, the stem diameter at the fifth flower cluster, the entire length, the step number of the flower cluster, and the root weight on Dec. 8, 2003. The results are shown in Table 7. The yield of the number of tomatoes per stock, the average weight of each tomato, the percentage of “A rank” tomatoes and sugar content were observed from the start to the harvest (July 18-Dec. 6, 2003). The results are shown in Table 8.

TABLE 7

| | Stem diameter | Stem diameter at | | | Root weight | |
|---|---|---|---|---|---|---|
| | at the soil surface part | the fifth flower cluster | Whole length | Step number of | of one stock | Root weight |
| | (mm) | (mm) | (cm) | flower cluster | (g) | index |
| Untreated plot | 11.9 | 10.1 | 295.2 | 13.7 | 36.5 | (100) |
| Experimental plot 1 | 12.2 | 10.8 | 328.3 | 15.0 | 34.7 | 95 |
| Experimental plot 2 | 11.7 | 11.6 | 343.2 | 15.0 | 37.2 | 102 |
| Experimental plot 3 | 12.6 | 11.2 | 309.2 | 13.8 | 41.7 | 114 |
| Experimental plot 4 | 11.6 | 10.9 | 328.3 | 14.8 | 41.0 | 112 |

Date of investigation: Dec. 8
Measured value: an average of 6 stocks

TABLE 8

| | Number of fruits | Yield per stock | | Average | Percentage of | |
|---|---|---|---|---|---|---|
| | per one stock | | Index of yield | fruit weight | Grade A rank | Sugar content |
| | (Nos.) | (g) | per one stock | (g) | (%) | (%) |
| Untreated plot | 20.3 | 2,200 | (100) | 108.4 | 98 | 6.3 |
| Experimental plot 1 | 22.7 | 2,609 | 119 | 114.9 | 98 | 6.7 |
| Experimental plot 2 | 21.5 | 2,595 | 118 | 120.7 | 96 | 6.5 |
| Experimental plot 3 | 24.2 | 2,971 | 135 | 122.8 | 99 | 5.7 |
| Experimental plot 4 | 23.8 | 2,975 | 135 | 125.0 | 99 | 6.2 |

Yield investigation: from the start of harvest to the end thereof (Jul. 18-Dec. 8)

Results:

Regarding growth, as compared with the untreated plot, Experimental plot 1 exhibited relatively better results, although inferior root weight was observed, and Experimental plots 2, 3 and 4 exhibited relatively better results, although some of them did not have an better stem diameter at the soil surface. Especially, in Experimental plots 3 and 4, the increase in root weight was around 10%. Therefore, the impregnated porous carbon material is especially effective for root growth.

With regard to the yield per one stock, as compared with the untreated plot, an increase of 19% was observed for Experimental plot 1 and 18% for Experimental plot 2. Experimental plots 3 and 4 exhibited a large increase of 35% as compared with the untreated plot. Furthermore, Experimental plots 3 and 4 gave the best average fruit weight.

From these results, the impregnated porous carbon material is effective for both the growth and yield of tomatoes.

### Example 5

### Cucumber

The effect on the growth of Cucumber “V-road” using the solid impregnated porous carbon material was examined.

In this example, the following was tested: solid porous carbon materials separately impregnated with the liquid fermentation by-products from the fermentations for the following amino acids: glutamine, glutamic acid, and lysine. In this experiment, the fermentation by-products (all from Ajinomoto Co., Inc.) were tested by themselves, that is, without the porous carbon material. A granular activated carbon “HJA-40Y” (Ajinomoto Fine-Techno. Co., Inc.) was also tested.

The amounts of the fertilizers were determined based on the nitrogen content.

In addition, a soil which had never been cultivated (virgin) was used to show the contrast with continuously cropped soil. This soil was “potting for pots” (trade name: PNP 17—manufactured by Klasmann-Deilmann GmbH). This soil had a pH of 6.0, and was prepared by adding a wetting agent and a fertilizer to 60% white peat, 20% black peat, 10% vermiculite (2-3 mm) and 10% pearlite (fine particles 1-7.5 mm). To this mixture, 60 kg/m2 of Clay Granvle was added. The ratio of N:P:K was 210:240:270 mg/L. For the continuously cropped soil, a soil in which cucumber had been continuously cropped for 10 years or more was used.

The compositions of the experimental pots were as follows. Six stocks were planted in each of the experimental pots.

(a) Uncultivated soil

1) Untreated pot: uncultivated soil alone (no test materials)

2) Experimental pot 1: uncultivated soil+2.24 g/pot of the solid impregnated porous carbon material (glutamine).

3) Experimental pot 2: uncultivated soil+2.24 g/pot of the solid impregnated porous carbon material (glutamic acid).

4) Experimental pot 3: uncultivated soil+2.24 g/pot of the solid impregnated porous carbon material (lysine).

5) Experimental pot 4: uncultivated soil+0.67 g/pot of the liquid glutamine fermentation by-product.

6) Experimental pot 5: uncultivated soil+0.67 g/pot of the liquid glutamic acid fermentation by-product.

7) Experimental plot 6: uncultivated soil+0.67 g/pot of the liquid lysine fermentation by-product.

8) Experimental pot 7: uncultivated soil+1.57 g/pot of “HJA-40Y”, then after 10 days, adding 0.67 g/pot of the liquid glutamine fermentation by-product.

9) Experimental pot 8: uncultivated soil+1.57 g/pot of “HJA-40Y”.

(b) Continuously cropped soil

1) Untreated pot: continuously cropped soil alone (no test materials)

2) Experimental pot 1: continuously cropped soil+2.24 g/pot of the solid impregnated porous carbon material (glutamine).

3) Experimental pot 2: continuously cropped soil+2.24 g/pot of the solid impregnated porous carbon material (glutamic acid).

4) Experimental pot 3: continuously cropped soil+2.24 g/pot of the solid impregnated porous carbon material (lysine).

5) Experimental pot 4: continuously cropped soil+0.67 g/pot of the liquid glutamine fermentation by-product.

6) Experimental pot 5: continuously cropped soil+0.67 g/pot of the liquid glutamic acid fermentation by-product.

7) Experimental pot 6: continuously cropped soil+0.67 g/pot of the liquid lysine fermentation by-product.

8) Experimental pot 7: continuously cropped soil+1.57 g/pot of “HJA-40Y”, then, after 10 days, adding 0.67 g/pot of the liquid glutamine fermentation by-product.

9) Experimental pot 8: continuously cropped soil+1.57 g/pot of “HJA-40Y”.

Observations:

On Sep. 29, 2004, seeds were sowed on a 72-cell tray which had been filled with “Traysubstrate”. This is the trade name for a culture soil prepared by adding a wetting agent and a fertilizer to a mixture of 25% white peat, 45% black peat, 25% vermiculite, and 5% pearlite (fine particles 0.6-2.5 mm), and then mixing with 100 g/m2 of a trace element (manufactured by Klasmann-Deilmann GmbH). The final ratios of N:P:K are 112:128:144 mg/L. The seedlings were raised at a soil and air temperature of 25° C., which was maintained by a heating wire.

On October 25, black plastic pots having a diameter of 9 cm were filled with the uncultivated soil and the continuously cropped soil, respectively. On the following day (October 26), the cucumber seedlings were transplanted to these pots, and 50 ml of water was added. The age of the cucumber seedlings when they were transplanted was such that one true leaf had developed. On October 29, it was observed that anthracnose had developed uniformly over all of the experimental pots. Therefore, “Quinondo flowable” diluted 1000× was administered. After that, management was carried out according to conventional methods, and on November 15 (48 days after planting, and 20 days after transplantation), plant height, stem diameter at the ground edge, fresh weight (above-ground and underground), and dried weight were observed. The results are shown in Table 9.

TABLE 9

| | Plant | Stem | Fresh | (above- | (under- | Dried |
|---|---|---|---|---|---|---|
| | height | diameter | weight | ground part) | ground part) | weight |
| | (cm) | (cm) | (g) | (g) | (g) | (g) |
| Virgin soil | | | | | | |
| Untreated plot | 14.1 | 0.4 | 8.1 | 6.9 | 1.3 | 3.1 |
| Experimental plot 1 | 15.1 | 0.5 | 11.0 | 8.8 | 2.2 | 3.6 |
| Experimental plot 2 | 17.8 | 0.5 | 12.4 | 10.3 | 2.1 | 3.7 |
| Experimental plot 3 | 18.0 | 0.5 | 12.1 | 9.6 | 2.5 | 3.8 |
| Experimental plot 4 | 15.6 | 0.5 | 7.8 | 6.7 | 1.0 | 2.9 |
| Experimental plot 5 | 12.8 | 0.4 | 6.0 | 5.3 | 0.7 | 2.3 |
| Experimental plot 6 | 17.7 | 0.5 | 8.9 | 7.7 | 1.1 | 2.2 |
| Experimental plot 7 | 16.0 | 0.4 | 8.7 | 7.2 | 1.5 | 3.0 |
| Experimental plot 8 | 15.7 | 0.4 | 8.6 | 7.2 | 1.4 | 3.1 |
| Continuously cropped soil | | | | | | |
| Virgin soil | 10.1 | 0.3 | 4.8 | 3.7 | 1.1 | 2.1 |
| Experimental plot 1 | 11.0 | 0.4 | 6.4 | 5.2 | 1.1 | 2.7 |
| Experimental plot 2 | 12.0 | 0.4 | 7.2 | 5.9 | 1.3 | 3.1 |
| Experimental plot 3 | 10.1 | 0.3 | 4.7 | 3.8 | 0.9 | 2.1 |
| Experimental plot 4 | 6.8 | 0.2 | 3.9 | 3.3 | 0.6 | 0.7 |
| Experimental plot 5 | 9.0 | 0.2 | 3.6 | 3.1 | 0.6 | 1.0 |
| Experimental plot 6 | 9.0 | 0.3 | 3.8 | 3.1 | 0.7 | 1.8 |
| Experimental plot 7 | 9.4 | 0.3 | 4.7 | 3.9 | 0.9 | 2.3 |
| Experimental plot 8 | 9.9 | 0.3 | 4.0 | 3.3 | 0.7 | 1.9 |

Measured value: an average of 5 stocks

Results:

(a) Uncultivated soil

Experimental pots 1, 2 and 3 (solid impregnated porous carbon materials) gave better results with regard to plant height as compared with the untreated pot, but were fairly equivalent to the other experimental pots.

With regard to the stem diameter, no differences were observed.

Experimental pots 1, 2 and 3 gave better results with regard to stem diameter than any other Experimental pots. In particular, the fresh weight of the under-ground part, that is, the root weight was around 180-150% as compared with that in the untreated plot.

Experimental pots 1, 2 and 3 gave better results in regards to the dried weight than any other Experimental pots, although there were no such large differences like with the fresh weight.

(b) Continuously cropped soil

Every Experimental pot of the continuously cropped soil was worse by all measures as compared with those for Experimental pots of the uncultivated soil, which was attributable to allelopacy.

Although these values were worse, Experimental pots 1, 2 and 3 gave better results in plant height, fresh weight, and dried weight than the other Experimental pots.

From these results, solid porous carbon material impregnated with the amino acid fermentation liquid by-product is effective for growth and yield in both uncultivated soil and continuously cropped soil. Furthermore, use of the solid material is more effective for growth and yield than use of the liquid amino acid fermentation by-product alone (Experimental pots 4, 5 and 6), use of the activated carbon alone (Experimental pots 8), and use of the liquid amino acid fermentation by-product and the activated carbon (Experimental plot 7).

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

1. A porous carbon material which is impregnated with a liquid by-product of an amino acid fermentation.

2. The porous carbon material of claim 1, which is a solid.

3. The porous carbon material of claim 1, which is a slurry.

4. The porous carbon material of claim 1, wherein the surface area of the said porous carbon material is from 600 to 2,000 m²/g.

5. The porous carbon material of claim 2 comprising from 1 to 70% by weight of said liquid by-product.

6. The porous carbon material of claim 3 comprising from 70 to 99% by weight of said liquid by-product.

7. A soil conditioner comprising said porous carbon material of claim 1.

8. A method for producing a porous carbon material impregnated with a liquid by-product of an amino acid fermentation comprising
A) mixing a porous carbon material with a liquid by-product of an amino acid fermentation, and
B) recovering the impregnated porous carbon material.

9. A method for producing a porous carbon material impregnated with a liquid by-product of an amino acid fermentation as a slurry comprising:
A) finely pulverizing the porous carbon material,
B) mixing the pulverized porous carbon material with the liquid by-product of an amino acid fermentation, and
C) recovering the porous carbon material impregnated with a liquid by-product of an amino acid fermentation as a slurry.
